(19) United States
(12) Patent Application Publication
(10) Pub. No.: US 2026/0017872 A1
(43) Pub. Date: Jan. 15, 2026

(54) SYSTEMS, DEVICES, AND METHODS FOR GENERATING A DISPLAY

(71) Applicant: SOFTWEIR INC., Georgetown (CA)

(72) Inventor: Michael WEIR, Georgetown (CA)

(21) Appl. No.: 19/335,460

(22) Filed: Sep. 22, 2025

Related U.S. Application Data
(63) Continuation of application No. PCT/CA2024/050360, filed on Mar. 25, 2024.
(60) Provisional application No. 63/455,051, filed on Mar. 28, 2023.

(51) Int. Cl. G06T 15/04; G02C 7/08; G06T 15/20; G06T 17/00; G06T 19/20

(52) U.S. Cl. CPC G06T 15/04; G02C 7/08; G06T 15/20; G06T 17/00; G06T 19/20

(57) ABSTRACT

Systems, devices, and methods of generating a display for a user having at least one vision condition are disclosed. The system can include at least one processor operable to receive at least one source image. For each source image, the processor can be operable to: render at least a portion of the source image to at least one texture resource to generate an imaged texture; generate a three-dimensional display scene including a three-dimensional model of an object; render the imaged texture to at least one surface of the three-dimensional model having dimensions that correspond to dimensions of the imaged texture; apply perspective visual effects to the at least one surface; and generate an adjusted three-dimensional display scene based on a view of the three-dimensional display scene with the perspective visual effects applied to the at least one surface. The adjusted three-dimensional scene can be displayable by a display device.

### CROSS-REFERENCE TO RELATED APPLICATIONS

This application is a continuation of PCT/CA2024/050360, filed on Mar. 25, 2024, which claims priority from U.S. Provisional Patent Application No. 63/455,051, filed on Mar. 28, 2023. The entire contents of PCT/CA2024/050360 and U.S. Provisional Patent Application No. 63/455,051 are herein incorporated by reference for all purposes.

### FIELD

The described embodiments relate generally to systems and methods of generating a display. In some example embodiments, the displays generated can accommodate a user having at least one vision condition.

### BACKGROUND

Vision conditions can cause a person to experience potentially numerous challenges in viewing their surroundings, including display screens and/or projections, and computer-generated displays therein. Some vision conditions can be treated with surgery and/or medication. As well, vision aids can assist people in living with various vision conditions. For example, eye glasses and/or contact lenses can correct or improve a vision effect caused by some vision conditions. More recently, wearable computing devices can also be used to correct or improve a user's vision.

### SUMMARY

The various embodiments described herein generally relate to systems, devices, and methods of generating a display for a user having at least one vision condition. The method can involve operating at least one processor in communication with a memory to: receive at least one source image; and for each source image, render at least a portion of the source image to at least one texture resource to generate an imaged texture; generate a three-dimensional display scene comprising a three-dimensional model of an object; render the imaged texture to the at least one surface of the three-dimensional model within the three-dimensional display scene; apply one or more perspective visual effects to the at least one surface of the three-dimensional model based on the one or more parameter settings corresponding to the user's at least one vision condition; and generate an adjusted three-dimensional display scene based on a view of the three-dimensional display scene with the perspective visual effects applied to the at least one surface of the three-dimensional model of the object therein. The three-dimensional model of the object can include a plurality of surfaces. At least one surface of the three-dimensional model can have dimensions that correspond to dimensions of the imaged texture. The adjusted three-dimensional scene can be displayable by a display device.

In some embodiments, the method can involve operating the at least one processor to receive a source video comprising a plurality of frames. Each frame can include a source image of the at least source image and a time at which the source image is displayed.

In some embodiments, the source video can be a stereo source video including a plurality of source video components. Each source video component can have a different perspective from other source video components of the plurality of source video components. The method can involve operating the at least one processor to generate an adjusted three-dimensional display scene for each source video component of the plurality of source video components.

In some embodiments, each frame can include a sequence of images; and the source image comprises a last image of the sequence of images.

In some embodiments, the method can involve operating the display device to display the adjusted three-dimensional display scene for each frame of the plurality of frames. The display device can be in communication with the at least one processor.

In some embodiments, the method can involve storing an adjusted video in the memory. The adjusted video can include the adjusted three-dimensional display scene for each frame of the plurality of frames.

In some embodiments, the method can involve operating the at least one processor to store the source image in the memory; and retrieve the source image from the memory for rendering at least a portion of the source image to the at least one texture resource to generate an imaged texture.

In some embodiments, the method can involve operating the at least one processor to detect at least one object within the source image and generate digitally encoded text data based on the at least one object.

In some embodiments, the at least one object can include one or more of a text object or a non-text object.

In some embodiments, the method can involve operating the at least one processor to generate location data associated with the digitally encoded text data. The location data can be based on a location of the associated object within the source image.

In some embodiments, the method can involve operating the at least one processor to apply at least one pre-processing visual effect to the source image based on the one or more parameter settings.

In some embodiments, the at least one pre-processing visual effect can include an adjustment of one or more of an orientation, a position, or a spacing of a viewing angle of the source image.

In some embodiments, the at least one pre-processing visual effect can include a rendering based on the digitally encoded text data and the location data.

In some embodiments, the method can involve operating the at least one processor to select the at least one texture resource such that dimensions of the at least one texture resource is not greater than corresponding dimensions of the source image.

In some embodiments, the dimensions of the at least one texture resource can be substantially equal to the corresponding dimensions of the source image; and the method can involve operating the at least one processor to render the source image to the at least one texture resource to generate an imaged texture.

In some embodiments, the at least one texture resource can include a plurality of texture resources; and the dimensions of the at least one texture resource can be the dimensions of a union of the plurality of texture resources.

In some embodiments, the method can involve operating the at least one processor to: store the imaged texture in the memory; and retrieve the imaged texture from the memory for rendering to the at least one surface of the three-dimensional model within the three-dimensional display scene.

In some embodiments, the method can involve operating the at least one processor to, prior to rendering the imaged texture to the at least one surface of the three-dimensional model within the three-dimensional display scene, apply at least one pre-perspective visual effect to the imaged texture based on the one or more parameter settings.

In some embodiments, the method can involve operating the at least one processor to apply at least a first pixel shader corresponding to the at least one pre-perspective visual effect.

In some embodiments, a ratio of the dimensions of the at least one surface of the three-dimensional model can be substantially equal to a ratio of the dimensions of the imaged texture.

In some embodiments, wherein operating the at least one processor to apply one or more perspective visual effects to the at least one surface of the three-dimensional model can involve operating the at least one processor to manipulate at least one edge of the at least one surface of the three-dimensional model.

In some embodiments, the one or more perspective visual effects can include one or more of an occlusion, warping, slicing, shifting, tearing, inserting, stretching, mapping, transforming, resizing, pinching, punching, or a cutout.

In some embodiments, the method can involve operating the at least one processor to apply one or more camera or lens effects to the view of the three-dimensional display scene with the perspective visual effects applied to the at least one surface of the three-dimensional model of the object therein.

In some embodiments, the one or more camera or lens effects can include one or more of an adjustment of a field-of-view, an adjustment of a position of a camera source, an adjustment of an angle of a camera source, a lens flare, or a lens bubble.

In some embodiments, the method can involve operating the at least one processor to: render the view of the three-dimensional display scene with the perspective visual effects applied to at least another texture resource to generate an adjusted view texture; and apply at least one post-perspective visual effect to the adjusted view texture based on the one or more parameter settings to provide the adjusted three-dimensional display scene.

In some embodiments, the method can involve operating the at least one processor to apply the one or more camera or lens effects to the view of the three-dimensional display scene with the perspective visual effects applied to the at least one surface of the three-dimensional model of the object therein prior to rendering the view of the three-dimensional display scene with the perspective visual effects applied to at least another texture resource to generate an adjusted view texture.

In some embodiments, the method can involve operating the at least one processor to apply at least a second pixel shader corresponding to the at least one post-perspective visual effect.

In some embodiments, the at least one post-perspective visual effect can include one or more of an adjustment of contrast, an adjustment of brightness, a feathering effect, or a color change.

In some embodiments, the at least one post-perspective visual effect can include a rendering based on the digitally encoded text data. The rendering can be applied in a pre-defined location within the adjusted view texture.

In some embodiments, the method can involve operating the at least one processor to generate audio data based on the digitally encoded text data.

In some embodiments, the method can involve determining the one or more parameter settings corresponding to the user's at least one vision condition.

In some embodiments, the method can involve storing the one or more parameter settings in the memory.

In some embodiments, the display device can include at least one of a head-mounted display device, a display screen, or a projector.

In some embodiments, the method can involve operating an imaging device in communication with the at least one processor to capture the source image.

In accordance with another broad aspect, there is generally disclosed a system for generating a display for a user having at least one vision condition. The system can include a memory and at least one processor in communication with the memory. The at least one processor can be operable to: receive at least one source image; and for each source image, render at least a portion of the source image to at least one texture resource to generate an imaged texture; generate a three-dimensional display scene including a three-dimensional model of an object; render the imaged texture to the at least one surface of the three-dimensional model within the three-dimensional display scene; apply one or more perspective visual effects to the at least one surface of the three-dimensional model based on one or more parameter settings corresponding to the user's at least one vision condition; and generate an adjusted three-dimensional display scene based on a view of the three-dimensional display scene with the perspective visual effects applied to the at least one surface of the three-dimensional model of the object therein. The three-dimensional model of the object can include a plurality of surfaces. At least one surface of the three-dimensional model can have dimensions that correspond to dimensions of the imaged texture. The adjusted three-dimensional scene can be displayable by a display device.

In some embodiments, the at least one processor can be operable to receive a source video comprising a plurality of frames. Each frame can include a source image of the at least source image and a time at which the source image is displayed.

In some embodiments, the source video can be a stereo source video including a plurality of source video components. Each source video component can have a different perspective from other source video components of the plurality of source video components. The at least one processor can be operable to generate an adjusted three-dimensional display scene for each source video component of the plurality of source video components.

In some embodiments, each frame can include a sequence of images; and the source image can include a last image of the sequence of images.

In some embodiments, the system can further include the display device. The display device can be operable to display the adjusted three-dimensional display scene for each frame of the plurality of frames. The display device can be in communication with the at least one processor.

In some embodiments, the at least one processor can be operable to store an adjusted video in the memory. The adjusted video can include the adjusted three-dimensional display scene for each frame of the plurality of frames.

In some embodiments, the at least one processor can be operable to: store the source image in the memory; and retrieve the source image from the memory for rendering at least a portion of the source image to the at least one texture resource to generate an imaged texture.

In some embodiments, the at least one processor can be operable to detect at least one object within the source image and generate digitally encoded text data based on the at least one object.

In some embodiments, the at least one object can include one or more of a text object or a non-text object.

In some embodiments, the at least one processor can be operable to generate location data associated with the digitally encoded text data, the location data being based on a location of the associated object within the source image.

In some embodiments, the at least one processor can be operable to apply at least one pre-processing visual effect to the source image based on the one or more parameter settings.

In some embodiments, the at least one pre-processing visual effect can include an adjustment of one or more of an orientation, a position, or a spacing of a viewing angle of the source image.

In some embodiments, the at least one pre-processing visual effect can include a rendering based on the digitally encoded text data and the location data.

In some embodiments, the at least one processor can be operable to select the at least one texture resource such that dimensions of the at least one texture resource is not greater than corresponding dimensions of the source image.

In some embodiments, the dimensions of the at least one texture resource is substantially equal to the corresponding dimensions of the source image; and the at least one processor can be operable to render the source image to the at least one texture resource to generate an imaged texture.

In some embodiments, the at least one texture resource can include a plurality of texture resources; and the dimensions of the at least one texture resource can include the dimensions of a union of the plurality of texture resources.

In some embodiments, the at least one processor can be operable to: store the imaged texture in the memory; and retrieve the imaged texture from the memory for rendering to the at least one surface of the three-dimensional model within the three-dimensional display scene.

In some embodiments, the display device can include a display memory; and the at least one processor can be operable to store the imaged texture in the display memory.

In some embodiments, the at least one processor can be operable to, prior to rendering the imaged texture to the at least one surface of the three-dimensional model within the three-dimensional display scene, apply at least one pre-perspective visual effect to the imaged texture based on the one or more parameter settings.

In some embodiments, the at least one processor can be operable to apply at least a first pixel shader corresponding to the at least one pre-perspective visual effect.

In some embodiments, a ratio of the dimensions of the at least one surface of the three-dimensional model can be substantially equal to a ratio of the dimensions of the imaged texture.

In some embodiments, the at least one processor can be operable to manipulate at least one edge of the at least one surface of the three-dimensional model.

In some embodiments, the one or more perspective visual effects can include one or more of an occlusion, warping, slicing, shifting, tearing, inserting, stretching, mapping, transforming, resizing, pinching, punching, or a cutout.

In some embodiments, the at least one processor can be operable to apply one or more camera or lens effects to the view of the three-dimensional display scene with the perspective visual effects applied to the at least one surface of the three-dimensional model of the object therein.

In some embodiments, the one or more camera or lens effects can include one or more of an adjustment of a field-of-view, an adjustment of a position of a camera source, an adjustment of an angle of a camera source, a lens flare, or a lens bubble.

In some embodiments, the at least one processor can be operable to: render the view of the three-dimensional display scene with the perspective visual effects applied to at least another texture resource to generate an adjusted view texture; and apply at least one post-perspective visual effect to the adjusted view texture based on the one or more parameter settings to provide the adjusted three-dimensional display scene.

In some embodiments, the at least one processor can be operable to apply the one or more camera or lens effects to the view of the three-dimensional display scene with the perspective visual effects applied to the at least one surface of the three-dimensional model of the object therein prior to rendering the view of the three-dimensional display scene with the perspective visual effects applied to at least another texture resource to generate an adjusted view texture.

In some embodiments, the at least one processor can be operable to apply at least a second pixel shader corresponding to the at least one post-perspective visual effect.

In some embodiments, the at least one post-perspective visual effect can include one or more of an adjustment of contrast, an adjustment of brightness, a feathering effect, or a color change.

In some embodiments, the at least one post-perspective visual effect can include a rendering based on the digitally encoded text data, the rendering being applied in a pre-defined location within the adjusted view texture.

In some embodiments, the at least one processor can be operable to generate audio data based on the digitally encoded text data.

In some embodiments, the at least one processor can be operable to determine the one or more parameter settings corresponding to the user's at least one vision condition.

In some embodiments, the one or more parameter settings can be stored in the memory.

In some embodiments, the display device can include at least one of a head-mounted display device, a display screen, or a projector.

In some embodiments, the at least one processor can be remote from the display device.

In some embodiments, the system can further include an imaging device in communication with the at least one processor to capture the source video.

In accordance with another broad aspect, there is generally disclosed a head-mounted device for a user having at least one vision condition. The head-mounted device can include at least one processor and a display component operable to display an adjusted three-dimensional scene for each frame of a plurality of frames for viewing by the user. The at least one processor can be in communication with a memory. The at least one processor can be operable to: receive at least one source image; and for each source image, render at least a portion of the source image to at least one texture resource to generate an imaged texture; generate a three-dimensional display scene comprising a three-dimensional model of an object; render the imaged texture to the at least one surface of the three-dimensional model within the three-dimensional display scene; apply one or more perspective visual effects to the at least one surface of the three-dimensional model based on one or more parameter settings corresponding to the user's at least one vision condition; and generate the adjusted three-dimensional display scene based on a view of the three-dimensional display scene with the perspective visual effects applied to the at least one surface of the three-dimensional model of the object therein. The three-dimensional model of the object can include a plurality of surfaces. At least one surface of the three-dimensional model can have dimensions that correspond to dimensions of the imaged texture.

### BRIEF DESCRIPTION OF THE DRAWINGS

Several embodiments will now be described in detail with reference to the drawings, in which:

FIG. 1 is a block diagram of example components of an example system for generating a display for a user having at least one vision condition, in accordance with an example embodiment;

FIG. 2 is a flowchart of an example method of generating a display for a user having at least one vision condition, in accordance with an example embodiment;

FIG. 3A are illustrations of example source images, in accordance with example embodiments;

FIG. 3B is an illustration of an example pre-processing visual effect applied to an example source image of FIG. 3A, in accordance with an example embodiment;

FIG. 3C is an illustration of an example imaged texture generated from the example source image of FIG. 3B, in accordance with an example embodiment;

FIG. 3D is an illustration of an example three-dimensional model of an object within a three-dimensional display scene, in accordance with an example embodiment;

FIG. 3E is an illustration of the example imaged texture of FIG. 3C rendered to at least one surface of the example three-dimensional model within the three-dimensional display scene of FIG. 3D, in accordance with an example embodiment;

FIG. 3F is an illustration of an example pre-perspective visual effect applied to imaged textures of an example stereo source video, in accordance with an example embodiment;

FIG. 3G is an illustration of example perspective visual effects applied to an example source image of FIG. 3A, in accordance with example embodiments;

FIG. 3H is an illustration of an example perspective visual effect of FIG. 3G applied to the example imaged texture rendered to at least one surface of FIG. 3E, in accordance with an example embodiment;

FIG. 3I is a diagram of an example display device for displaying an adjusted three-dimensional scene, in accordance with an example embodiment;

FIG. 3J is an illustration of an example camera or lens effect applied to an example stereo source video, in accordance with an example embodiment;

FIG. 3K is an illustration of an example camera or lens effect applied to the view of the three-dimensional display scene of FIG. 3H, in accordance with an example embodiment; and

FIG. 3L is an illustration of example post-perspective visual effects applied to an example stereo source video, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Vision aids can be used to correct or improve a vision effect caused by the user's vision condition. For example, vision conditions and effects can include, but are not limited to, nystagmus, color blindness, lack of depth perception, double vision, tunnel vision, peripheral vision, partial area vision, spots, clouds, fog, distortion, aphakia, light sensitivity, halos, glare, slow light adjustment, reduced quality of vision, low vision, visual field warping, dead spots, discoloration, or reduced ocular muscle ability.

Various wearable vision aids have been developed, typically addressing only one particular vision condition or effect. However, persons having a vision condition can often experience several distinct vision effects. Accordingly, prior wearable vision aids tend to provide limited improvements to the user's overall vision by targeting one of potentially many vision effects experienced by the user.

Disclosed herein are systems, methods, and devices for generating a display for a user having at least one vision condition. For example, the disclosed systems, methods, and devices can involve operating a processor to receive a source video and to generate a display of the source video that accommodates the user's vision condition. In particular, the processor can apply various effects according to the user's at least one vision condition.

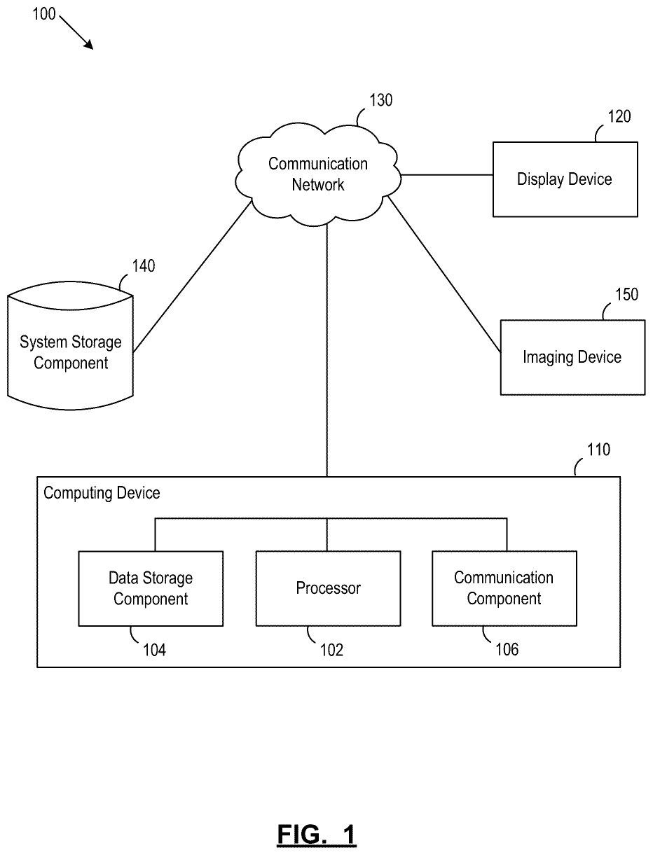

Referring now to FIG. 1, shown therein a block diagram illustrating an example system 100 for generating a display for a user having at least one vision condition. The system 100 can include a computing device 110, a display device 120, a communication network 130, a system storage component 140, and an imaging device 150.

Although the example system 100 shown in FIG. 1 includes a display device 120, a communication network 130, a system storage component 140, and an imaging device 150, in some embodiments, the system 100 may not include the display device 120, the communication network 130, the system storage component 140, and/or the imaging device 150.

The computing device 110 can include a data storage component 104, a processor 102, a communication component 106. The computing device 110 can be implemented as a personal computer, laptop, mobile device, smartphone, electronic tablet device, or server.

Components 110, 102, 104, 106, 120, and 150 are illustrated separately in FIG. 1. In some embodiments, one or more of the components 110, 102, 104, 106, 120, and 150 can be combined into fewer components, or separated into further components. In some embodiments, parts of a component can be combined with another part of another component.

The processor 102 can control the operation of the computing device 110. The processor 102 can include any suitable processors, controllers, digital signal processors, graphics processing units, application specific integrated circuits (ASICs), field programmable gate arrays (FPGAs), microcontrollers, and/or other suitably programmed or programmable logic circuits that can provide sufficient processing power depending on the configuration, purposes and requirements of the computing device 110. In some embodiments, the processor 102 can include more than one processor with each processor being configured to perform different dedicated tasks.

The processor 102 can operate the data storage component 104, the communication component 106, the display device 120, the system storage component 140, and/or the imaging device 150. For example, the processor 102 can operate the imaging device 150 to capture an image and store the image on the system storage component 140. The processor 102 can also retrieve the stored image from the system storage component 140 and display the stored video at the display device 120.

The data storage component 104 can include RAM, ROM, one or more hard drives, one or more flash drives or some other suitable data storage elements such as disk drives. For example, the data storage component 104 can include volatile and non-volatile memory. Non-volatile memory can store computer programs consisting of computer-executable instructions, which can be loaded into the volatile memory for execution by the processor 102. Operating the processor 102 to carry out a function can involve executing instructions (e.g., a software program) that can be stored in the data storage component 104. The data storage component 104 can also store data input to, or output from, the processor 102, which can result from the course of executing the computer-executable instructions, for example.

The data storage component 104 can store data related to the operation of the computing device 110, the display device 120, and/or the imaging device 150. The data storage component 104 can also store data in respect of one or more parameter settings, graphics data, and image data. The parameter settings can be based on the user's at least one vision condition. The parameter settings can correspond to the left eye and/or the right eye. In some embodiments, the parameter settings can be the same for the left eye and the right eye. In some embodiments, the parameter settings can be different for the left eye and the right eye. In some embodiments, the parameter settings can correspond to only the left eye or only the right eye. In some embodiments, the one or more parameter settings can be pre-determined.

The graphics data can include texture resources and three-dimensional models. Three-dimensional models can be rendered as three-dimensional objects within a three-dimensional display scene. Texture resources can be rendered to surfaces of three-dimensional objects to provide color and detail to the surfaces. Texture resources can include images.

The image data can include any image data, including video (e.g., a sequence of images) and stereo video (e.g., multiple video components having different perspectives). The image data can be captured by a camera, including a live camera of the user's environment. The image data can be computer-generated, including a three-dimensional scene for a computer game or application.

The data storage component 104 can also store software applications executable by the processor 102 to facilitate communication with other computing devices.

In some embodiments, the data storage component 104 can instead be the system storage component 140, which can be accessible via the communication network 130.

In some embodiments, the data storage component 104 can store data that is more current based on the operation of the computing device 110, and the system storage component 140 can store data that is considered by the computing device 110 to unlikely be used in the immediate future. For example, the data storage component 104 can store parameter settings and texture resources only, whereas the system storage component 140 can store source videos, which is typically less frequently accessed.

The communication component 106 can include any interface that enables the computing device 110 to communicate with various devices and other systems. For example, the communication component 106 can facilitate communication with the display device 120, the system storage component 140, and/or other computing devices via the communication network 130.

In some embodiments, the communication component 106 can include at least one of a serial port, a parallel port or a USB port. The communication component 106 may also include a wireless transmitter, receiver, or transceiver for communicating with a wireless communications network, such as the communication network. The wireless communications network can include at least one of an Internet, Local Area Network (LAN), Ethernet, Firewire, modem, fiber, or digital subscriber line connection. Various combinations of these elements may be incorporated within the communication component 106. For example, the communication component 106 may receive input from various input devices, such as a mouse, a keyboard, a touch screen, a thumbwheel, a track-pad, a track-ball, a card-reader, voice recognition software and the like depending on the requirements and implementation of the computing device 110.

The communication network 130 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the computing device 110, the display device 120, the system storage component 140, and/or other computing devices.

The display device 120 can be in communication with the computing device 110. As shown in FIG. 1, the display device 120 can communicate with the computing device 110 via the communication network 130. In some embodiments, the display device 120 can communicate directly with the computing device 110. The display device 120 and the computing device 110 can communicate directly when the display device 120 is local to the computing device 110.

The display device 120 can be any device capable of displaying images, and/or retrieving images, and/or storing images. For example, the display device 120 can be a head-mounted display device, a display screen, and/or a projector. Other display devices are possible. The display device 120 can include but is not limited to one or more screens, a virtual reality headset, and/or any other suitable device with display functionalities. Although not shown in FIG. 1, in some embodiments, the display device 120 can include a dedicated processor and/or a dedicated data storage component.

The imaging device 150 can be in communication with the computing device 110. As shown in FIG. 1, the imaging device 150 can communicate with the computing device 110 via the communication network 130. In some embodiments, the imaging device 150 can communicate directly with the computing device 110. The imaging device 150 and the computing device 110 can communicate directly when the imaging device 150 is local to the computing device 110.

The imaging device 150 can be any device capable of capturing images, and/or generating images, and/or storing images. For example, the imaging device can be a camera, including a Universal Serial Bus (USB) camera, a video recorder, or any other suitable imaging device. Although not shown in FIG. 1, in some embodiments, the imaging device 150 can include a dedicated processor and/or a dedicated data storage component.

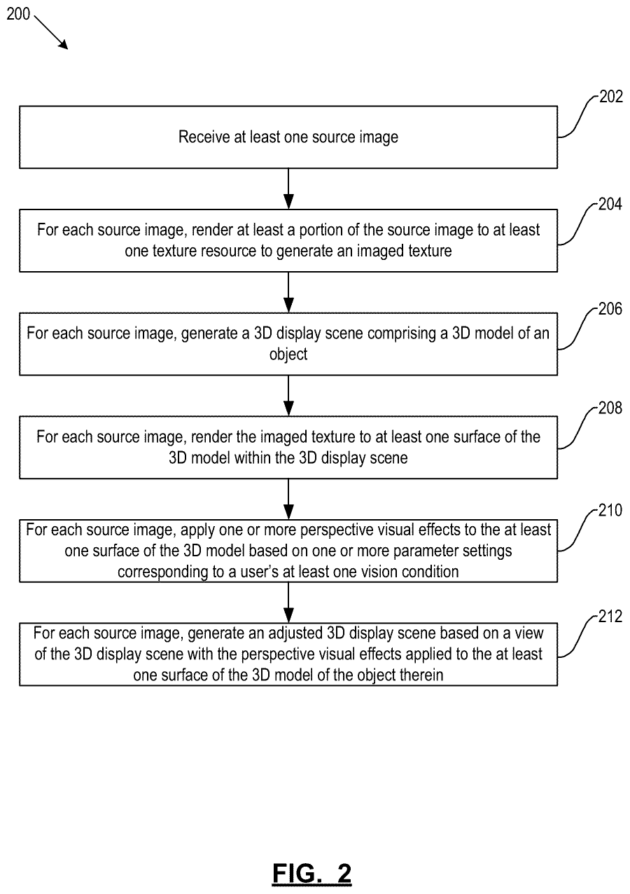

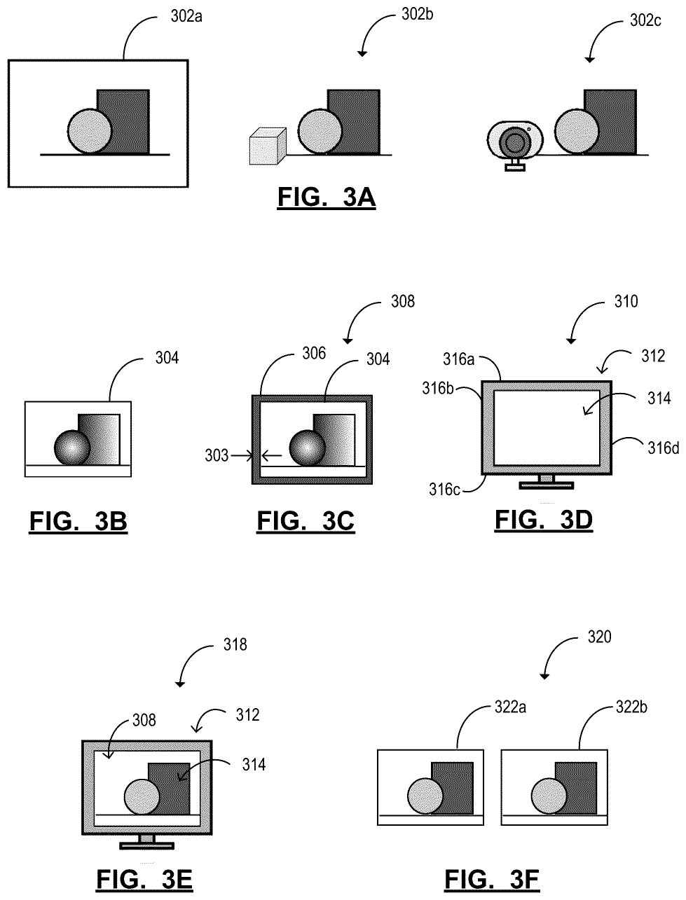

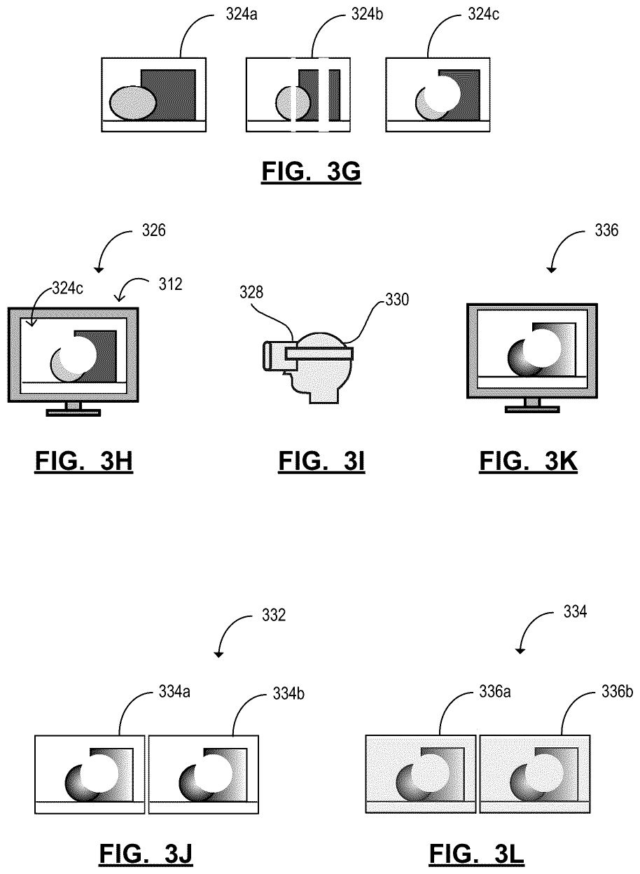

Referring now to FIG. 2, shown therein a flowchart of an example method 200 for generating a display for a user having at least one vision condition. To assist with the description of method 200, reference will be made simultaneously to FIGS. 3A, 3B, 3C, 3D, 3E, 3F, 3G, 3H, 3I, and 3J. The method 200 can be implemented by a computing device, such as the computing device 110, having at least one processor, such as the processor 102 in communication with a memory, such as the data storage component 104.

Method 200 can begin at 202 when the processor 102 receives at least one source image. The source image can be a digital image. The digital image can have any number of pixels. The digital image can be any size and any resolution. For example, the digital image can be a graphical user interface for a computing device, such as desktop image 302a for a computer screen, as illustrated in FIG. 3A. In another example, the source image can be a three-dimensional scene, such as three-dimensional scene 302b illustrated in FIG. 3A. The three-dimensional scene 302b can be a scene from a three-dimensional application or video game. In another example, the source image can be a captured image, such as captured image 302c illustrated in FIG. 3A. The captured image can be captured by an imaging device, such as imaging device 150. Although only three example source images 302a, 302b, 302c (herein referred to as the source image 302) are shown in FIG. 3A, other source images 302 are possible.

In some embodiments, the at least one source image 302 can be a plurality of source images 302. Furthermore, the source image 302 can be from a source video that includes a plurality of frames. That is, the processor 102 can receive a source video. Each frame of the source video can include a source image 302 and a time at which the source image 302 is displayed within the duration of the source video. For example, the at least one source image 302 can be a plurality of captured images 302c from a video camera recording.

Each frame of the source video can include a sequence of images. In some embodiments, a last image of the sequence of images of a frame can be taken as the source image 302 for the frame. In some embodiments, the source image of each frame can be stored in memory. In some embodiments, the processor 102 can use an image from the source video that has the highest resolution, irrespective of whether the resolution is supported by the display device 120. Using the highest resolution image can avoid blurriness.

In some embodiments, the source video can be a stereo video having a plurality of video components. For example, each video component of the stereo video can have a different perspective from other source video components of the plurality of source video components.

In some embodiments, the source image 302 can be generated by the processor 102 (e.g., desktop image 302a or three-dimensional scene 302b) or received from the imaging device 150. In some embodiments, the source image 302 can be generated in real-time. In some embodiments, the source image 302 can be obtained from memory, such as the data storage component 104 or the system storage component 140 via a communication network, such as the communication network 130. In some embodiments, after receiving the source image 302 from the imaging device 150 or system storage component 140, the processor 102 can store the source image 302 in the data storage component 104.

In some embodiments, the processor 102 can process the source image 302 to generate digitally encoded text data based on objects shown within the source image 302. In some embodiments, the processor 102 can scan the source image 302, interpret the objects shown within the source image 302, and generate digitally encoded text data corresponding to the interpretation of the objects. In some embodiments, the generation of digitally encoded text data by the processor 102 can involve the use of artificial intelligence. The digitally encoded text data can be stored in the data storage component 104.

In some embodiments, the objects shown within the source image 302 can include text. The processor 102 can scan the source image 302 and recognize text in the source image 302 to generate digitally encoded text data. That is, the processor 102 can perform optical character recognition (OCR) on the source image 302 to generate the digitally encoded text data. Furthermore, the processor 102 can determine a location of the text object shown within the source image 302 and generate location data that defines the location of the text object shown within the source image 302. The processor 102 can associate the location data with the corresponding digitally encoded text data.

In some embodiments, the objects shown within the source image 302 can include images of non-text objects. Interpreting the source image 302 can involve interpreting non-text objects shown within the source image 302. Interpretation of the source image 302 can include, for example, a description of the source image 302, such as a description of non-text objects and/or details shown within the source image 302. Interpretation of the source image 302 can involve the use of artificial intelligence. The processor 102 can also determine a location of the non-text object shown within the source image 302 and generate location data that defines the location of the non-text object shown within the source image 302. The processor 102 can associate the location data with the corresponding digitally encoded text data.

In some embodiments, the processor 102 can apply at least one pre-processing visual effect to the source image 302. In particular, pre-processing visual effects can be applied when the source image 302 is a three-dimensional scene 302b. For example, the three-dimensional scene 302b can be computer-generated, such as a game or other software application. The pre-processing visual effect can be based on one or more parameter settings corresponding to the user's vision condition. Examples of pre-processing visual effects include, but are not limited to, an adjustment of an orientation, an adjustment of a position, an adjustment of a spacing of a viewing angle of the source image 302, or any combination thereof. FIG. 3B shows an illustration of an example pre-processing visual effect 304 applied to the source image 302.

In some embodiments, the processor 102 can determine the one or more parameter settings corresponding to the user's at least one vision condition. In some embodiments, the at least one or more parameter settings can be pre-determined. The one or more parameter settings can be stored in the data storage component 104.

In some embodiments, the digitally encoded text data with location data can be used to apply the at least one pre-processing visual effects 304 to the source image 302. For example, the at least one pre-processing visual effect 304 can be a rendering of the digitally encoded text data. In some embodiments, the rendering of digitally encoded text data that corresponds to text in the source image 302 can be clearer and/or larger than the original text. In some embodiments, the rendering of digitally encoded text data can have a location within the source image 302 that matches, or is similar to the location of the original text within the source image 302.

In some embodiments, the rendering of the digitally encoded text data that corresponds to an object in the source image 302 can include generic image data for a given object. For example, the original object in the source image 302 can be an apple and the rendering can be a generic apple icon applied to the source image 302. In some embodiments, the newly rendered generic apple icon can be located within the source image 302 that matches, or is similar to the location of the original apple within the source image 302.

In some embodiments, the at least one pre-processing visual effect 304 can be graphical effects, such as outlines around text or objects within the source image 302 to improve the appearance of the original text or original object. For example, a dark outline can provide greater contrast against the original text or original object to make it easier to spot by the user.

Returning now to FIG. 2, at 204, the processor 102 can, for each source image 302, render at least a portion of the source image 302 to at least one texture resource to generate an imaged texture. FIG. 3C shows an illustration of an example imaged texture 308 in which a source image 302 is rendered to a texture resource 306. Although imaged texture 308 is shown with pre-processing visual effects 304 applied to the source image 302, in some embodiments, the source image 302 can be rendered to the texture resource 306 without pre-processing visual effects 304. In some embodiments, the source image 302 can be retrieved from the data storage component 104 for rendering to the texture resource 306.

In some embodiments, the processor 102 can select the at least one texture resource 306 based on the technical limitations of the processor 102 and/or the display device 120. Some processors 102 and/or display devices 120 may not support very large texture resources 306. For example, video cards can have a certain limit in respect of image resolution associated with a texture resource 306.

In some embodiments, the dimensions of the at least one texture resource 306 can be substantially equal to the corresponding dimensions of the source image 302. For example, in the case of a rectangular source image, the length and width of the at least one texture resource can be substantially equal to the length and width of the source image, respectively. The processor 102 can render the entirety of the source image 302 to the at least one texture resource 306 to generate the imaged texture 308.

In some embodiments, the processor 102 can select a plurality of texture resources 306 such that dimensions of the union of the plurality of texture resources 306 can be substantially equal to the corresponding dimensions of the source image 302. For example, the processor 102 can select a plurality of texture resource 306 when the processor 102 is unable to support a very large texture resource 306. In the case of a rectangular source image and the processor 102 selecting two texture resources, a total length of the first and the second texture resource can be substantially equal to the length of the source image; and a total width of the first and the second texture resource can be substantially equal to the width of the source image. The processor 102 can render the entirety of the source image 302 to the plurality of texture resources 306 to generate the imaged texture.

In some embodiments, the dimensions of the at least one texture resource 306 can be different from the dimensions of the source image 302. However, when a dimension of the at least one texture resource 306 is larger than the corresponding dimension of the source image, blurriness can occur in the imaged texture 308 and result in a loss of detail. Accordingly, the processor 102 can select the at least one texture resource 306 such that dimensions of the at least one texture resource 306 are not greater than corresponding dimensions of the source image 302. Furthermore, the processor 102 can select the at least one texture resource 306 such that a small portion (i.e., a small number of pixels, such as 303) of the source image 302 would not be rendered to the at least one texture resource 306 and be omitted from the imaged texture 308. That is, the processor 102 can select the at least one texture resource 306 such that dimensions of the at least one texture resource 306 are only slightly less than the dimensions of the source image 302.

In some embodiments, the processor 102 can store the imaged texture 308 in the data storage component 104. The processor 102 can subsequently retrieve the imaged texture 308 for use in a three-dimensional scene.

At 206, the processor 102 can generate a three-dimensional display scene. The three-dimensional display scene can include a three-dimensional model of an object. The three-dimensional model of the object can include a plurality of surfaces. At least one surface of the three-dimensional model can have dimensions that correspond to dimensions of the imaged texture 308.

The three-dimensional model of the object can include edges and/or vertices. The surfaces of the three-dimensional model can include polygonal segments, such as triangles, circles, squares, rectangles, or any other geometric shape. In some embodiments, the three-dimensional model of the object can include tens to thousands of polygonal segments. Each polygonal segment of the three-dimensional model of the object can independently have a portion of the imaged texture 308 applied thereon.

Referring now to FIG. 3D, shown therein is an illustration of an example three-dimensional model 312 of an object within a three-dimensional display scene 310. As shown in FIG. 3D, the object of the three-dimensional model 312 is a computer monitor. The three-dimensional model of the computer monitor 312, that is a virtual computer monitor, can include a plurality of surfaces, one of which is a display screen 314. The display screen 314 shown in FIG. 3D is a rectangle and includes edges 316a, 316b, 316c, and 316d (collectively referred to as edges 316).

In some embodiments, the three-dimensional display scene 310 can include adjustable settings. The adjustable settings can be customized. For example, the adjustable settings can be customized based on the user's preferences such as but not limited to whether the user prefers low lighting or a particular style of wallpaper.

Returning now to FIG. 2, it should be noted that although FIG. 2 shows the processor 102 generating a three-dimensional display scene 310 at 206 after generating an image texture at 204, the processor 102 can generate the three-dimensional display scene 310 before generating the imaged texture 308.

At 208, the processor 102 renders the imaged texture 308 to the at least one surface 314 of the three-dimensional model 312 within the three-dimensional display scene 310. As shown in the three-dimensional display scene 318 of FIG. 3E, the imaged texture 308 is rendered to the display screen 314 of the virtual computer monitor 312. Although FIG. 3E shows the imaged texture 308 only rendered to the display screen 314 of the virtual computer monitor 312, the virtual computer monitor 312 includes additional surfaces and imaged textures can be rendered to any surface of the virtual computer monitor 312.

The at least one surface 314 of the three-dimensional model 312 can have dimensions that correspond to dimensions of the imaged texture 308. That is, the length and width of the display screen 314 can match, or be substantially equal to, the length and width of the imaged texture 308, respectively. In some embodiments, a ratio of the dimensions of the at least one surface 314 of the three-dimensional model corresponds to a ratio of the dimensions of the imaged texture 308. For example, a ratio of the length to the width of the display screen 314 can match, or be substantially equal to, to a ratio of the length to the width of the imaged texture 308.

Although the entire imaged texture 308 is rendered to the display screen 314 of the virtual computer monitor 312, in some embodiments, only a portion of the imaged texture 308 is rendered to the at least one surface 314 of the three-dimensional model 312 within the three-dimensional display scene 310.

In some embodiments, the processor 102 can retrieve the imaged texture 308 from the data storage component 104 for rendering to the at least one surface 314 of the three-dimensional model 312.

In some embodiments, the processor 102 can apply at least one pre-perspective visual effect to the imaged texture 308. That is, prior to rendering the imaged texture 308 to the at least one surface 314, the processor 102 can apply at least one pre-perspective visual effect to the imaged texture 308. The pre-perspective visual effects can be based on the one or more parameter settings corresponding to the user's vision condition. Pre-perspective visual effects generally include image effects without perspective.

Referring now to FIG. 3F, shown therein is an illustration of an example pre-perspective visual effect 320 applied to imaged textures of a stereo source video. That is, pre-perspective visual effects 320 can be applied to each component of the stereo source video, such as a left eye component 322a and a right eye component 322b. Furthermore, the pre-perspective visual effects 320 applied to the left eye component 322a can be different or same as the pre-perspective visual effects 320 applied to the right eye component 322b. In some embodiments, applying pre-perspective visual effects can involve, but is not limited to, applying pixel shaders. Any number of pixel shaders can be applied.

Returning now to FIG. 2, at 210, the processor 102 can apply one or more perspective visual effects to the at least one surface 314 of the three-dimensional model 312. The perspective visual effect can be based on one or more parameter settings corresponding to the user's vision condition. Examples of perspective visual effects include, but are not limited to, an occlusion, warping, slicing, shifting, tearing, inserting, stretching, mapping, transforming, resizing, pinching, punching, a cutout, or any combination thereof. Perspective visual effects can generally involve any manipulation of the at least one surface 314 of the three-dimensional model 312. For example, a perspective visual effect can involve manipulating at least one edge 316 of the display screen 314 of the virtual computer monitor 312.

FIG. 3G shows illustrations of example perspective visual effects. In particular, image 324a is an example stretching effect applied to the source image 302; image 324b is an example slicing effect applied to the source image 302; and image 324c is an example cutout effect applied to the source image 302. For the purpose of illustration, FIG. 3G illustrates perspective visual effects applied to the source image 302. However, it will be understood that at 210, the processor 102 applies perspective visual effects to the at least one surface 314 of the three-dimensional model 312 to which the imaged texture 308 has been rendered to.

For example, FIG. 3H shows an illustration 326 of the example cutout effect 324c applied to the at least one surface 314 of the three-dimensional model 312 to which the imaged texture 308 has been rendered to. The perspective visual effects 324 can be applied to each component of a stereo source video, such as a left eye component and a right eye component (not shown in FIG. 3H). That is, the same perspective visual effects 324 can be applied to the left eye component and the right eye component of a stereo source video.

By rendering the source image 302 to at least one texture resource to generate an imaged texture 308 and rendering the imaged texture to the at least one surface 314 of the three-dimensional model 312 of an object in the three-dimensional display scene, the method 200 allow for the application of a wide variety of visual effects and thus, can accommodate a wide variety of vision conditions. Other methods of generating displays that accommodate vision conditions can modify images on a pixel basis and in doing so, are limited in the number and/or types of visual effects that can be applied.

Returning now to FIG. 2, at 212, the processor 102 can generate an adjusted three-dimensional display scene based on a view of the three-dimensional display scene with the perspective visual effects applied to the at least one surface 314 of the three-dimensional model 312 of the object therein. The adjusted three-dimensional scene can be displayable by a display device 120. In some embodiments, the display device 120 can be a virtual reality headset, such as virtual reality headset 328 worn by user 330 in FIG. 3I. In some embodiments, the display device 120 can be a display screen or projector.

When the source image is a video including a plurality of frames, the processor 102 can generate an adjusted three-dimensional display scene for each frame of the plurality of frames. That is, the processor 102 can generate an imaged texture 204, generate a three-dimensional display scene 206, render the imaged texture to at least one surface of a three-dimensional model of the three-dimensional display scene 208, apply one or more perspective visual effects to the at least one surface 210, and generate the adjusted three-dimensional display scene 212 for each frame of the plurality of frames. Thus, the processor 102 can generate a plurality of adjusted three-dimensional display scenes and the display device 120 can display the plurality of adjusted three-dimensional display scenes for the source video.

Furthermore, when the source video is a stereo video, the processor 102 can generate an adjusted three-dimensional display scene for each source video component of the plurality of source video components. That is, the processor 102 can generate an imaged texture 204, generate a three-dimensional display scene 206, render the imaged texture to at least one surface of a three-dimensional model of the three-dimensional display scene 208, apply one or more perspective visual effects to the at least one surface 210, and generate the adjusted three-dimensional display scene 212 each frame of the plurality of frames and each source video component of the plurality of source video components.

In some embodiments, the processor 102 can apply one or more camera or lens effects to the view of the three-dimensional display scene with the perspective visual effects applied to the at least one surface 314 of the three-dimensional model 312 of the object therein. That is, after applying the perspective visual effects to the at least one surface 314, the processor 102 can apply camera and/or lens effects prior to generating the adjusted three-dimensional display scene 212.

The camera or lens effects can be based on the one or more parameter settings corresponding to the user's vision condition. Examples of the camera or lens effects include, but are not limited to, an adjustment of a field-of-view, an adjustment of a position of a camera source, an adjustment of an angle of a camera source, a lens flare, a lens bubble, or any combination thereof.

Referring now to FIG. 3J, shown therein is an illustration of an example camera or lens effect 332 applied to a stereo source video. Camera or lens effects 332 can be applied to each component of the stereo source video, such as a left eye component 334a and a right eye component 334b. Furthermore, the camera or lens effects 332 applied to the left eye component 334a can be different or same as the camera or lens effects 332 applied to the right eye component 334b. Referring now to FIG. 3K, shown therein is an illustration 336 of the camera or lens effect 332 of FIG. 3K applied to the view of the three-dimensional display scene with perspective visual effects, such as cutout effect 324c of FIG. 3H, applied to the display screen 314 of the virtual computer monitor.

In some embodiments, to provide the adjusted three-dimensional display scene, the processor 102 can render the view of the three-dimensional display scene with the perspective visual effects applied to at least another texture resource to generate an adjusted view texture and apply at least one post-perspective visual effect to the adjusted view texture based on the one or more parameter settings. That is, after applying the perspective visual effects to the at least one surface 314, the processor 102 can render the view of the three-dimensional display scene to at least another texture resource to generate an adjusted view texture and apply at least one post-perspective visual effect to the adjusted view texture based on the one or more parameter settings. Similar to 204, the processor 102 can select the other texture resource based on the technical limitations of the processor 102 and/or the display device 120 and to avoid blurriness in the adjusted view texture.

Furthermore, in some embodiments, the processor 102 can render the view of the three-dimensional display scene with the perspective visual effects and camera or lens effects applied to at least another texture resource to generate an adjusted view texture. That is, the post-perspective visual effect can be applied after applying the one or more camera or lens effects to the view of the three-dimensional display scene with the perspective visual effects applied.

The post-perspective visual effects can be based on the one or more parameter settings corresponding to the user's vision condition. Examples of the post-perspective visual effects include, but are not limited to, an adjustment of contrast, an adjustment of brightness, a feathering effect, a color change, or any combination thereof. In some embodiments, applying post-perspective visual effects can involve, but is not limited to, applying pixel shaders. Any number of pixel shaders can be applied.

Referring now to FIG. 3L, shown therein is an illustration of example post-perspective visual effects 334 applied to a stereo source video. Post-perspective visual effects 334 can be applied to each component of the stereo source video, such as a left eye component 336a and a right eye component 336b. Furthermore, the post-perspective visual effects 334 applied to the left eye component 336a can be different or same as the post-perspective visual effects 334 applied to the right eye component 336b.

In some embodiments, the processor 102 can also use the digitally encoded text data to apply post-perspective visual effects 334. For example, the post-perspective visual effect 334 can be a rendering of the digitally encoded text data. The rendering of the digitally encoded text data can be clearer and/or larger than the original text. In some embodiments, the rendering of the digitally encoded text data can have a pre-defined location within the source image 302. For example, the pre-defined location can relate to a standard location, similar to closed captioning. That is, the location of the rendering of the digitally encoded text data may not correspond to the location of the original text.

In some embodiments, the processor 102 can use the digitally encoded text data to generate audio. In some embodiments, the processor 102 can implement a text-to-speech program to generate audio data corresponding to the digitally encoded text data. In some embodiments, the audio data can include a vocalization of the digitally encoded text data and/or sound effects related to the digitally encoded text data. For example, the source image 302 can include an image of a dog, the digitally encoded text data can include the text “dog”, and the sound effect can include a dog's bark.

In some embodiments, the adjusted three-dimensional display scene is displayed at a display device 120 contemporaneously as it is generated. For example, method 200 can be implemented at a computing device 110 and displayed at a virtual reality headset 328 that is local to the computing device 110. In another example, the method 200 can be implemented at a server and displayed at the virtual reality headset 328 that is remote from the server. Furthermore, the server can also store the adjusted three-dimensional display scene in system storage component 140 and the user computing device 110 can subsequently access the adjusted three-dimensional display scene from the system storage component 140 for display at the virtual reality headset 328. In yet another example, the method 200 can be implemented at a first computing device 110 upon capture of the source image by an imaging device 150. The first computing device 110 can store the adjusted three-dimensional display scene in system storage component 140 and a second computing device 110 can subsequently access the adjusted three-dimensional display scene from the system storage component 140 for display.

In some embodiments, the adjusted three-dimensional display scene can incorporate one or more of the following modifications to source video to accommodate a user's vision condition: eye tracking, offset, hue shifting, hue compression, saturation elevation, visual depth detection, combining eyes, minification, fish eye, shift graph, magnification, feather, peak compression, pin-hole effects, brightness balance, and contrast/brightness adjustments.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

1. A method of generating a display for a user having at least one vision condition, the method comprising:
receiving, by a processor, at least one source image;
retrieving, by the processor, at least one texture resource; and
for each source image,
rendering by the processor at least a portion of the source image to the at least one texture resource to generate an imaged texture;
generating, by the processor, a three-dimensional display scene comprising a three-dimensional model of an object, the three-dimensional model of the object comprising a plurality of surfaces, at least one surface of the three-dimensional model having dimensions that correspond to dimensions of the imaged texture;
rendering, by the processor, the imaged texture to the at least one surface of the three-dimensional model within the three-dimensional display scene to generate a textured three-dimensional model;
modifying, by the processor, the at least one surface of the textured three-dimensional model based on one or more parameter settings corresponding to the user's at least one vision condition to generate a modified textured three-dimensional model, wherein the at least one surface of the texture three-dimensional model is modified by applying one or more perspective visual effects to the at least one surface of the three-dimensional model; and
generating, by the processor, an adjusted three-dimensional display scene based on a view of the three-dimensional display scene with the modified textured three-dimensional model replacing the textured three-dimensional model, the adjusted three-dimensional scene being displayable by a display device.

2. The method of claim 1, further comprising receiving a source video comprising a plurality of frames, each frame comprising a source image of the at least one source image and a time at which the source image is displayed.

3. The method of claim 2, wherein the source video comprises a stereo source video comprising a plurality of source video components, each source video component having a different perspective from other source video components of the plurality of source video components; and the method further comprises generating a source-specific adjusted three-dimensional display scene for each source video component of the plurality of source video components.

4. The method of claim 2, wherein each frame comprises a sequence of images; and the source image comprises a last image of the sequence of images.

5. The method of claim 2, further comprising displaying the adjusted three-dimensional display scene for each frame of the plurality of frames on the display device in communication with the processor.

6. The method of claim 2, further comprising storing an adjusted video in a memory in communication with the processor, the adjusted video comprising the adjusted three-dimensional display scene for each frame of the plurality of frames.

7. The method of claim 1, further comprising, prior to rendering the imaged texture to the at least one surface of the three-dimensional model within the three-dimensional display scene, applying at least one pre-perspective visual effect to the imaged texture based on the one or more parameter settings.

8. The method of claim 1, wherein applying one or more perspective visual effects to the at least one surface of the three-dimensional model comprises manipulating at least one edge of the at least one surface of the three-dimensional model.

9. The method of claim 1, further comprising generating the adjusted three-dimensional display scene by:
rendering the view of the three-dimensional display scene with the modified textured three-dimensional model to at least another texture resource to generate an adjusted view texture; and
applying at least one post-perspective visual effect to the adjusted view texture based on the one or more parameter settings to provide the adjusted three-dimensional display scene.

10. A system for generating a display for a user having at least one vision condition, the system comprising:
at least one processor; and
a non-transitory storage memory in communication with the processor;
wherein the at least one processor is configured to:
receive at least one source image;
retrieve, from the memory, at least one texture resource; and
for each source image,
render at least a portion of the source image to the at least one texture resource to generate an imaged texture;
generate a three-dimensional display scene comprising a three-dimensional model of an object, the three-dimensional model of the object comprising a plurality of surfaces, at least one surface of the three-dimensional model having dimensions that correspond to dimensions of the imaged texture;
render the imaged texture to the at least one surface of the three-dimensional model within the three-dimensional display scene to generate a textured three-dimensional model;
modify the at least one surface of the textured three-dimensional model based on one or more parameter settings corresponding to the user's at least one vision condition to generate a modified textured three-dimensional model, wherein the at least one surface of the textured three-dimensional model is modified by applying one or more perspective visual effects to the at least one surface of the three-dimensional model; and
generate an adjusted three-dimensional display scene based on a view of the three-dimensional display scene with the modified textured three-dimensional model replacing the textured three-dimensional model, the adjusted three-dimensional scene being displayable by a display device in communication with the processor.

11. The system of claim 10, wherein the at least one processor is configured to receive a source video comprising a plurality of frames, each frame comprising a source image of the at least one source image and a time at which the source image is displayed.

12. The system of claim 11, wherein the source video comprises a stereo source video comprising a plurality of source video components, each source video component having a different perspective from other source video components of the plurality of source video components; and the at least one processor is configured to generate a source-specific adjusted three-dimensional display scene for each source video component of the plurality of source video components.

13. The system of claim 11, wherein each frame comprises a sequence of images; and the source image comprises a last image of the sequence of images.

14. The system of claim 11, wherein the at least one processor is configured to display the adjusted three-dimensional display scene for each frame of the plurality of frames on the display device.

15. The system of claim 11, wherein the at least one processor is configured to store an adjusted video in the memory, the adjusted video comprising the adjusted three-dimensional display scene for each frame of the plurality of frames.

16. The system of claim 10, wherein the at least one processor is configured to, prior to rendering the imaged texture to the at least one surface of the three-dimensional model within the three-dimensional display scene, apply at least one pre-perspective visual effect to the imaged texture based on the one or more parameter settings.

17. The system of claim 10, wherein the at least one processor is configured to apply the one or more perspective visual effects to the at least one surface of the three-dimensional model by manipulating at least one edge of the at least one surface of the three-dimensional model.

18. The system of claim 10, wherein the at least one processor is configured to generate the adjusted three-dimensional display scene by:
rendering the view of the three-dimensional display scene with the modified textured three-dimensional model to at least another texture resource to generate an adjusted view texture; and
applying at least one post-perspective visual effect to the adjusted view texture based on the one or more parameter settings to provide the adjusted three-dimensional display scene.

19. A head-mounted device for a user having at least one vision condition, the device comprising:
at least one processor;
a non-transitory storage memory in communication with the processor; and
a display in communication with the processor;
wherein the at least one processor is configured to:
receive a source video comprising a plurality of frames comprising a plurality of source images, each frame comprising a frame-specific source image of the plurality of source images and a time at which that frame-specific source image is displayed;
retrieve, from the memory, at least one texture resource; and
for each source image in the plurality of source images,
render at least a portion of the source image to the at least one texture resource to generate an imaged texture;
generate a three-dimensional display scene comprising a three-dimensional model of an object, the three-dimensional model of the object comprising a plurality of surfaces, at least one surface of the three-dimensional model having dimensions that correspond to dimensions of the imaged texture;
render the imaged texture to the at least one surface of the three-dimensional model within the three-dimensional display scene to generate a textured three-dimensional model;
modify the at least one surface of the textured three-dimensional model based on one or more parameter settings corresponding to the user's at least one vision condition to generate a modified textured three-dimensional model, wherein the at least one surface of the textured three-dimensional model is modified by applying one or more perspective visual effects to the at least one surface of the three-dimensional model; and
generate an adjusted three-dimensional display scene based on a view of the three-dimensional display scene with the modified textured three-dimensional model replacing the textured three-dimensional model; and
display the adjusted three-dimensional scene on the display for each frame of the plurality of frames for viewing by the user.

20. The device of claim 19, wherein:
the source video comprises a stereo source video comprising a plurality of source video components, each source video component having a different perspective from other source video components of the plurality of source video components; and
the at least one processor is configured to generate an adjusted three-dimensional display scene for each source video component of the plurality of source video components.
